(19) United States
(12) Patent Application Publication
(10) Pub. No.: US 2024/0008070 A1
(43) Pub. Date: Jan. 4, 2024

(54) SYSTEM AND METHOD FOR PROTECTING INCUMBENT AND HIGH PRIORITY USERS OF UNLICENSED SPECTRUM

(71) Applicant: CHARTER COMMUNICATIONS OPERATING, LLC, St. Louis, MO (US)

(72) Inventor: Ahmed BENCHEIKH, Aurora, CO (US)

(73) Assignee: CHARTER COMMUNICATIONS OPERATING, LLC, St. Louis, MO (OS)

(21) Appl. No.: 18/206,350

(22) Filed: Jun. 6, 2023

Related U.S. Application Data
(60) Provisional application No. 63/357,818, filed on Jul. 1, 2022.

(51) Int. Cl. H04W 72/566; H04L 5/00; H04W 16/14; H04W 72/0446

(52) U.S. Cl. CPC H04W 72/566; H04L 5/006; H04L 5/0048; H04W 16/14; H04W 72/0446

(57) ABSTRACT

Various embodiments comprise systems, methods, architectures, mechanisms and apparatus for managing the use of unlicensed spectrum by access points (APs) whereby specific exclusions of specific unlicensed channels/frequencies in a specific location area during specific timeslots may be automatically propagated to, and invoked at, geographically relevant APs using such unlicensed spectrum (e.g., 802.11 Wi-Fi access points, 5G NR-U eNBs/gNBs, or other devices/technologies) so as to avoid interference with incumbent/priority users of the unlicensed spectrum.

### CROSS-REFERENCE TO RELATED APPLICATIONS

This application claims priority to U.S. Provisional Application 63/357,818, filed on Jul. 1, 2022 (Attorney Docket #CHTR/2020-215), which is incorporated herein by reference in its entirety.

### FIELD OF THE DISCLOSURE

The present disclosure generally relates to the use of unlicensed spectrum in accordance with FCC requirements.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

The United States Federal Communications Commission (FCC) has adopted new rules for the 6 GHz radio frequency (RF) band, releasing an additional 1,200 MHz of spectrum for unlicensed low-power devices/use. The FCC also modernized the use of the 5.9 GHz band by making the lower 45 megahertz of the band (5.850-5.895 GHz) available for unlicensed uses like Wi-Fi (e.g., IEEE 802.11xx) and re-allocating the upper 30 megahertz of the band (5.895 GHz-GHz) to the modern Cellular Vehicle-to-Everything (C-V2X) technology.

This additional spectrum may be used to support various use cases and applications such as those enabling immersive Gigabit services in existing 5 GHz and future 6 GHz bands, as long as the use of such spectrum by incumbent users and high priority users is preserved. Hence, it is critical to ensure full protection of these incumbent and/or high priority users while utilizing newly available spectrum in a beneficial manner. There may also be exclusion zones defined where some of these unlicensed channels are not authorized for use by non-incumbent users.

One known effective but complicated mechanism for protecting incumbent/priority users against interference is Dynamic Frequency Selection (DFS), in which a dedicated radio chain is used to scan DFS spectrum. If the spectrum is unoccupied (unused by an incumbent/priority user), then a Wi-Fi access point (AP) is authorized to use it. If occupied, then the AP must vacate the channel within a prescribed period of time. The coordination for this process is performed at the chipset level. This method is expensive as it requires a dedicated radio. In another method, the Wi-Fi AP exits its current channel to scan for DFS spectrum usage, switching to this spectrum if it is available, and avoiding (or exiting) this spectrum if it is occupied. This has the advantage of not requiring a dedicated scanning radio but is inefficient in terms of use of the WiFi radio.

APs capable of unlicensed spectrum usage may be deployed in very large numbers over a coverage area or footprint by a network operator (e.g., an Internet Service Provider, a telecommunications network provider, a Multi-Service operator (MSO), and so on). There is no automated process for protecting incumbent/priority users against interference from these APs.

### SUMMARY

Various embodiments comprise systems, methods, architectures, mechanisms and apparatus for managing the use of unlicensed spectrum by access points (APs) whereby specific exclusions of specific unlicensed channels/frequencies in a specific location area during specific timeslots may be automatically propagated to, and invoked at, geographically relevant APs using such unlicensed spectrum (e.g., 802.11 Wi-Fi access points, 5G NR-U eNBs/gNBs, or other devices/technologies) so as to avoid interference with incumbent/priority users of the unlicensed spectrum.

An unlicensed channel(s) exclusion enforcement method according to an embodiment comprises: at an access point (AP), in response to an initialization of the AP, retrieving an exclusion configuration from provider equipment (PE) communicatively coupled thereto via a predefined communications channel, the exclusion configuration defining an unlicensed spectrum portion and a time period during which the AP may not use the defined unlicensed spectrum portion; configuring unlicensed channel usage of the AP in accordance with the exclusion configuration; and configuring unlicensed channel usage of the AP in accordance with an updated exclusion configuration received from the PE.

Additional objects, advantages, and novel features of the invention will be set forth in part in the description which follows and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention provided herein, and the detailed description of the embodiments given below, serve to explain the principles of the present invention.

FIG. 1 depicts a block diagram of a network services architecture suitable for use in illustrating the various embodiments;

FIG. 2 depicts a flow diagram of an unlicensed channel exclusion enforcement method according to an embodiment; and

FIG. 3 depicts a flow diagram of an access point (AP) power up and operational method according to an embodiment.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various embodiments comprise systems, methods, architectures, mechanisms and apparatus for managing the use of unlicensed spectrum whereby specific exclusions of specific unlicensed channels/frequencies in a specific location area during specific timeslots may be automatically propagated to, and invoked at, geographically relevant access points using such unlicensed spectrum (e.g., 802.11 Wi-Fi access points, 5G NR-U eNBs/gNBs, or other devices/technologies) so as to avoid interference with incumbent/priority users of the unlicensed spectrum. Further, the various embodiments enforce unlicensed channel/frequency exclusion at each AP even if the AP is subject to a soft reset or power cycling off and back on.

Various embodiments find particular utility within the context of networks of access points (APs), such as deployed over a coverage area or footprint by network operators (e.g., an internet service provider (ISP), a telecommunications network, a Multi-Service Operator (MSO), and the like). In particular, various embodiments provide a mechanism whereby exclusions of specific unlicensed channels/frequencies in a specific location area during specific timeslots may be automatically propagated to, and invoked at, geographically relevant APs within a network so as to avoid interference with incumbent/priority users.

Unlicensed spectrum may comprise, illustratively, various spectral regions released for unlicensed use by the FCC under the condition that such use does not negatively impact incumbent/priority users of the spectrum, such as in the 5.9 GHz and 6 GHz bands.

Various deficiencies in the prior art are addressed by systems, methods, and apparatus for configuring wireless network equipment to utilize unlicensed radio frequency (RF) spectral regions while ensuring the prioritized use of such spectral regions by incumbent users. For example, wireless networking equipment, access points (APs) and the like capable of using unlicensed spectral regions are further configured to determine whether proximate incumbent users exist, and responsively adapt their operation to utilize the unlicensed spectrum in a manner that avoids compromising the operating rights of proximate incumbent users.

In various embodiments, an AP may be configured to provide a mechanism capable of confirming to third parties or network management entities that AP operation is, in fact, configured in a manner consistent with ensuring the preservation of spectrum utilization rights of proximate incumbent users.

The various embodiments provide a cost-effective method to support AFC in accordance with FCC requirements while avoiding the need for a dedicated scanner for incumbent signals and avoiding the need for integrating a costly GPS solution on each AP (which would not work effectively indoor anyway). The embodiments drive the geo-location of the AP based on the customer address, optionally augmented by higher accuracy/precision using other techniques such as the GPS location from a user equipment/device (UE) connected to the AP. Various embodiments may also use an altimeter to derive/report the Z coordinate.

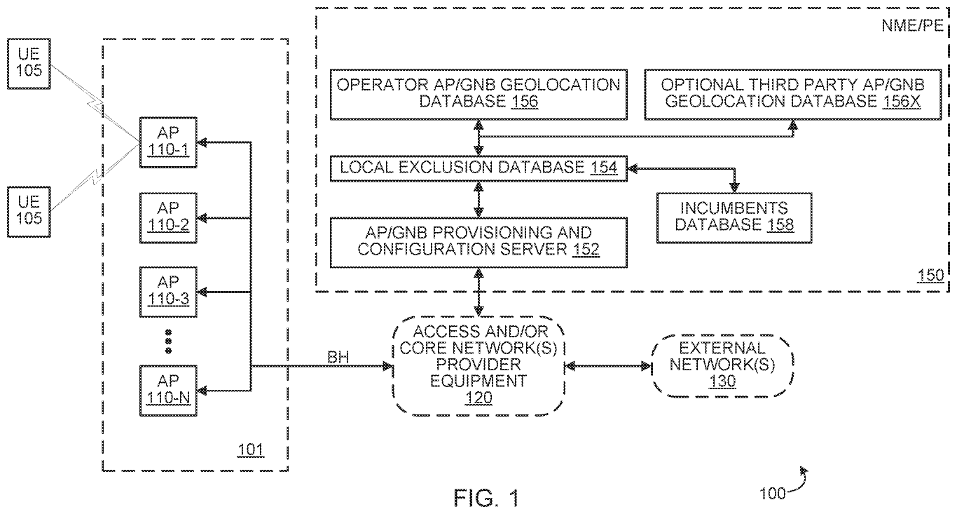

FIG. 1 depicts a high-level block diagram of a network services architecture benefiting from various embodiments. It will be noted that network services architectures of other types, configurations, technologies and so on may also benefit from the various embodiments. As such, it should not be construed that the embodiments are only appropriate for use in the context of a network services architecture of the type depicted herein with respect to FIG. 1. Generally speaking, the network services architecture may be any architecture suitable for enabling a network operator to provide network services to subscribers and the like as discussed herein.

Specifically, FIG. 1 depicts a network 101 comprising a plurality of wireless access points (APs) 110-1 through 110-N (collectively APs 110) in communication with various provider equipment (PE) associated with access and/or core networks 120, such via a backhaul network BH (illustratively, in one of many possible embodiments, APs 110 coupled to respective local cable modems (CMs), which in turn communicate with an associated cable modem termination systems (CMTSs), which in turn communicate with various access network elements as is known). The access and/or core networks 120 are depicted as communicating with external networks 130 such as the Internet, an IP Multimedia Subsystem (IMS), or any other type of external network. It is noted that the use of unlicensed spectrum is described with respect to APs 110 such as Wi-Fi APs, 5G NR-U eNBs/gNBs and, more generally, any network access devices that may be configured to use unlicensed spectrum such as described herein with respect to the APs 110.

The APs 110 and access/core networks 120 may be part of a fixed wireline access network (FWAN) operated by a network operator, wherein subscribers associated with UE 105 receive network services in accordance with a contract with the network operator. The access network 120 may comprise any type of access network, such as a wireless or wireline network configured to support network services and other traffic between APs and core/external networks.

The APs 110 comprise wireless devices such as 802.11 Wi-Fi access points, 5G NR-U eNBs/gNBs, and the like implementing wireless access point (AP) functions such as may be deployed at home, business or other locations and configured to wirelessly communicate with and provide network services to UE 105 via unlicensed spectrum such as described herein.

UE 105 receives network services (e.g., voice, streaming media, data upload/download etc.) via the APs 110, such as illustratively provided by a remote server (not shown) coupled to the external networks 130 and communicating therethrough with the access and/or core networks 120 and BH networks. The UE 105 may comprise any type of endpoint device configured for use in accordance with the various embodiments, such as a mobile handset, laptop, tablet, and the like capable of communicating with an AP 110.

As depicted in FIG. 1, the various backhaul (BH), access and core networks 120 handle user data or data plane (DP) functions, such as transporting internet protocol (IP) data traffic (i.e., incoming and outgoing IP packets) between the User Equipment (UE) 105 (via a AP 110) and the external networks 130, handling control plane signaling, and performing various functions as is known.

In various embodiments, various network management equipment (NME) 150 cooperates with the access and/or core networks 120, as well as the BH networks, to perform various network management functions, such as AP configuration, monitoring, usage reporting, network optimization, congestion monitoring, and so on as is known.

It is noted that the NME 150, access and/or core networks 120, BH networks and/or other provider equipment (PE) may provide the various functions described herein with respect to the embodiments; namely, managing and enforcing specific exclusions of unlicensed channels/frequencies in specific locations during specific timeslots of operation for relevant wireless access points (APs) within the network 101 so as to avoid unlicensed channel use conflicts with incumbent/priority users. The various functions discussed herein with respect to the monitoring entity may be distributed across one or more actual or instantiated PE entities such as servers, routers, switches, controllers, network managers, elements managers, gateways, and special purpose devices within or associated with the relevant network operator.

As depicted in FIG. 1, the NME 150 includes various elements configured to perform various control and processing operations in accordance with the embodiments, such as an incumbent data retrieval and processing server 151, an access point (AP) geolocation database 156, and a AP/gNB provisioning and configuration server 152, a local exclusion database 154, an operator's AP/gNB geolocation database 156, an optional third party AP/gNB geolocation database 156X, and an incumbents database 158.

As depicted in FIG. 1, the access point (AP) geolocation database 156 is used to store geolocation data associated with the various APs 110 within the coverage area or footprint of the network 101 (more generally, the APs 110 associated with the relevant network operator). The AP/gNB geolocation database 156 may be periodically updated by a server within the NME 150. It is noted that AP geo-location may be determined by various means, such as the address of service where such AP is installed, a GPS receiver integrated into the AP, a GPS location of a device attached to or proximate such an AP, and/or a combination thereof to improve accuracy and address gaps when one method may not work (e.g., such as GPS when the AP is indoors).

As depicted in FIG. 1, the incumbent data retrieval and processing server 151 communicates with a remote restricted channels database (not shown) used to store data indicative of channels or frequency bands to be used by incumbent and high priority users, the times or timeslots associated with such use, and the location(s) associated with such use. That is, when an incumbent or high priority user intends to use unlicensed spectrum, the user registers the channel/band to be used, a specific geo-location associated with such use, and a specified period of time for such use. This may be a government database or a third-party database.

The local exclusion database 154 is updated via incumbent/priority exclusion data (i.e., channels/frequencies to be used, location of use, time of use) for at least the locations served by the relevant network operator (e.g., the area associated with the APs 110 of the network 101) retrieved from the incumbents database 158. In various embodiments, the local exclusion database 154 receives all the information from the incumbents database 158, and this information is then filtered such that only the information that is relevant/applicable to the network operator is retained (i.e., only that information pertaining to APs within the network operator's geographic operating area) and used to update the local exclusion zones for the network operator.

The NME 150 uses the incumbent/priority exclusion data from the local exclusion database 154 and the AP location data from the AP/gNB geolocation database 156 to identify APs 110 that will be impacted by incumbent/priority use of the unlicensed spectrum, as well as the extent of that impact (time duration, frequency bands, channels, power, etc.).

The provisioning and configuration server 152 is configured to perform various provisioning and configuration functions with respect to the APs 110 forming the network 101, including adapting the operational configurations of any APs 110 located in an area impacted by incumbent/priority use of the unlicensed spectrum. It is noted that the NME 150 elements such may comprise separate entities or servers as generally described herein or may be implemented in the same entity or server.

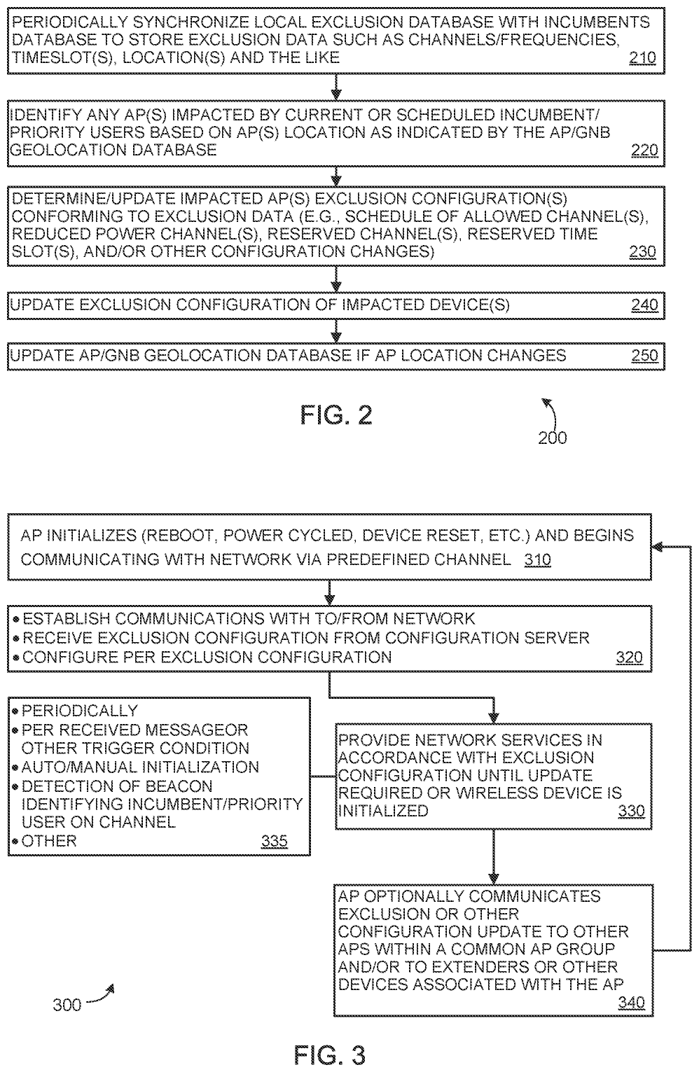

Generally speaking, the NMS 150 and/or other provider equipment is configured to ensure that exclusion data supplied by incumbent/priority users of unlicensed spectrum is quickly retrieved and used to update an exclusion configuration at each AP 110 so that spectrum usage conflict with incumbent/priority users is avoided in an automated manner. The exclusion data may be retrieved/pulled at a regular interval, or it may be pushed automatically to the provider equipment in case of any changes. The relevant operation of the NME 150 and/or other provider equipment will be discussed in more detail below with respect to FIG. 2.

The NME 150 may be further configured to provide a resource management mechanism which manages the power, coverage, spectrum bands, channels within a spectrum band, radiation pattern so as to avoid radiating in a direction that creates interference with an incumbent/high priority user, and/or other characteristics of individual APs 110 in order avoid interference with incumbent/priority users while optimizing the quality of the services delivered to UE 105 via the APs 110. Generally speaking, the NME 150 manages various operational aspects of the APs 110 and possibly the UE 105 connected thereto in accordance with operator's policies, subscriber/user profiles (e.g., such as defined in service agreements) and the like. For example, each UE may be associated with a corresponding subscriber/user profile having defined therein guaranteed minimum levels of service, such as a minimum AP download (DL) throughput, minimum upload (UL) throughput, and/or other minimum QoS levels.

Various elements or portions thereof depicted in FIG. 1 and having functions described herein are implemented at least in part as computing devices having communications capabilities, including for example the UE 105, APs 110, BH networks, access and/or core networks 120, NME 150, and various other elements as described herein. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces, input/output interfaces and the like.

As such, the various functions depicted and described herein may be implemented at the elements or portions thereof as hardware or a combination of software and hardware, such as by using a general-purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

FIG. 2 depicts a flow diagram of an unlicensed channel exclusion enforcement method according to an embodiment. The method 200 of FIG. 2 contemplates various functions performed by the APs 110, the NME 150, and/or other entities to generate exclusion configuration information for the APs 110 so that the APs 110 may communicate via unlicensed spectrum in a manner that does not interfere with incumbent/priority users.

At step 210, the method 200 synchronizes or updates the local exclusions database 154 with at least the relevant portions of a remote incumbents/high priority users information database (or exclusion zones information database), such as the incumbents database 158. Exclusion data such as channels/frequencies to be used by an incumbent/priority user, timeslots) associated with that use, and location(s) associated with that use may be supplied by the incumbent/priority user to incumbents database 158, which information may then be retrieved and used by the network operator. Broadly speaking, the incumbents database 158 enables an incumbent/priority operator to identify the location of incumbent/priority users associated with current or planned use of unlicensed spectral regions and/or channels such as on specific date(s), specific time slot(s), specific power levels, and/or specific locations (e.g., zip code(s), radius from a transmit location depending on transmit power level, etc.) such that other users may avoid conflicting use of the unlicensed spectrum.

At step 220, the method 200 identifies any AP(s) 110 impacted by current or scheduled requirements of incumbent/priority users in accordance with, illustratively, the operator AP/gNB geolocation database 156 (and/or optional third-party operator AP/gNB geolocation database 156X). which is indicative of the location of all the APs 110 deployed within the network 101. That is, the known locations of APs in the deployed network are used to identify those APs located within or near a transmission footprint associated with current or scheduled incumbent/priority users of unlicensed spectrum.

At step 230, the method 200 determines or updates exclusion configurations of any impacted AP(s) so as to avoid a use of unlicensed spectrum in conflict with incumbent/priority users. Such configuration changes may be reflected by establishing a schedule of allowed frequencies, allowed channels, reduced power levels for certain channels, reserved channels, reserved time slots, and/or other configuration changes. Generally speaking, the exclusion configuration may comprise any information useful in modifying operation of AP(s) to enforce incumbents protection rules as defined by the regulator or other entities.

At step 240, the method 200 updates the exclusion configuration(s) of impacted AP(s) in accordance with the determinations made at step 230. In those cases where exclusion configuration or channel configuration profile updates have been made, a push notification may be sent to the network operator and to the appropriate entities informing them of such configuration change.

At step 250, in the event that an AP 110 has changed location, the new AP location is provided to the operator AP/gNB geolocation database 156 and/or optional third-party operator AP/gNB geolocation database 156X. In various embodiments, location and other information is gathered to identify WAPs and the like installed within a relevant proximity of an incumbent or priority user, and/or other users affected by a restriction of some sort. For example, multiple APs in the vicinity of an incumbent user may generate an aggregate interference that is unacceptable, even if the individual APs are operating within appropriate operational ranges (transmit channels, frequencies, power levels, time slots, etc.).

Generally speaking, allowed channels are configured in, illustratively, servers and the like implementing the NME 150 and related functions using planned or actual use/presence information provided by incumbent/priority users or third parties a specific location. This use/presence information is preferably updated in a dynamic manner to reflect current planned or actual use/presence information, since incumbent/priority users may not be active at all times. Similarly, incumbent/priority users may have previously reported planned activity or location information, channels to be used and the like where such planned activity or location information has since changed. The NME 150 maps that information to a set of APs that may be impacted and updates their config to bar those channels from use during that time period in that location. The incumbent/high priority user may inform the NME 150 that the user is releasing the spectrum and that makes those channels available for use by those APs again.

FIG. 3 depicts a flow diagram of an AP power up and operational method according to an embodiment. Specifically, FIG. 3 depicts a method 300 suitable for use by, illustratively, a deployed AP 110 in a wireless network configured to use unlicensed spectrum bands in regions where such use is limited by exclusion data due to incumbent protection rules as discussed herein.

At step 310, as part of an initialization procedure (e.g., in response to a reboot, power-on, device reset and the like) an AP (per box 315, e.g., a wireless router, eNB, gNB, etc.) configured to use unlicensed spectrum under applicable incumbent protection rules begins advertising its availability and generally communicating via a predefined safe channel (i.e., a channel that does not create any interference to any incumbent or high priority users).

As step 320, the AP establishes a communications path through a backhaul network or access network of the appropriate network operator, to communicate with provider equipment (PE) such as the provisioning and configuration server 152. As part of this initial communication with PE, the AP receives various information including an exclusion configuration defining a schedule of allowed channels for current and future use by the AP, such as based on exclusion data provided by incumbent/priority users as discussed above with respect to FIG. 2. The exclusion configuration defines the unlicensed channels/frequencies that the AP will be excluded from using, and the timeslot(s) during which such exclusion is in force. Further, the exclusion configuration may further define respective excluded channels/frequencies and timeslots for different locations of the AP.

Generally speaking, the exclusion configuration may comprise a distinct configuration command or file or may comprise an adaptation to a broader AP configuration command or file. Further, the exclusion configuration may be provided instead as an allowable use configuration, which achieves substantially the same operational effect. The exclusion configuration and/or other channel configuration information/profile may define which channels and/or subchannels may be used, maximum power levels for some or all of these channels and/or subchannels, as well as other transmission channel parameters.

Further at step 320, the AP is configured for communication with user equipment (UE) associated with subscribers to the network via any of the current/scheduled allowed channels/time slots, and in conformance with any power limitations or other parameter limitations defined in the exclusion or other configuration. The AP may use the current/scheduled allowed channels until a configuration profile update is required.

At step 330, the AP provides network services in accordance with the exclusion or other configuration until such time as an update is required or otherwise indicated.

Referring to box 335, the exclusion or other configuration update may be initiated at predetermined time intervals (e.g., periodic update schedule), in response to a trigger message received from a network management entity (e.g., a push notification from NME 150), in response to an automatic or manual initialization procedure, in response to detecting channel interference or congestion above a threshold level, or in response to some other criteria.

In some embodiments, the AP may scan the transmission channel it is using to identify congestion, interference and the like potentially associated with an incumbent/priority user. In further embodiments, the AP may scan the transmission channel it is currently using to detect beacons or other signal identifying information associated with incumbent/priority users. For example, in response to the AP determining that the current transmission channel characteristics have degraded, or that an incumbent/priority user may be attempting to use the current transmission channel, the AP may migrate network services sessions to another unlicensed channel.

The incumbent/priority user signal may comprise an identifying beacon associated with an incumbent/priority user that is periodically or continually transmitted by the incumbent/high priority user. The beacon may include identification information, energy level, location information, channel in use information and/or other information associated with the incumbent/high priority user transmitting the bacon. The beacon may comprise a coded signal or encrypted key generically indicative of the status of a transmitting entity as being an incumbent/priority user (i.e., the same or similar being used by each incumbent/priority user). In various embodiments, the beacon may provide geolocation, frequencies, power levels, antenna coverage pattern and so on associated with incumbent/priority users.

To maintain the configuration, when a new AP 110 is installed and powers up, it reaches out to the NME 150 to check if there are any restricted channels. The AP receives an updated config indicating which channels may not be used and when. This same process is applied when an existing AP powers up/reboots. In this manner, each AP enforces the updated configuration preventing it from using the restricted channels in its location for the specified period of time. When a restriction expires, the AP receives an updated configuration through the cloud controller allowing it to resume use of the previously restricted channels.

At optional step 340, in response to the AP receiving an exclusion or other configuration update, the AP may communicate the updated exclusion or configuration to any other APs within a common AP group, such as a group of APs proximate each other or within a defined area such that an exclusion or other configuration update would be applicable to each of the APs within the common AP group, or would be applicable to the group members so as to avoid a group or aggregate interference to an incumbent or high priority user. Further, the AP may communicate the updated exclusion or configuration to any extenders or other devices associated with that AP.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. An unlicensed channel(s) exclusion enforcement method, comprising:
at an access point (AP), in response to an initialization of the AP, retrieving an exclusion configuration from provider equipment (PE) communicatively coupled thereto via a predefined communications channel, the exclusion configuration defining an unlicensed spectrum portion and a time period during which the AP may not use the defined unlicensed spectrum portion;
at the AP, configuring unlicensed channel usage of the AP in accordance with the exclusion configuration; and
at the AP, configuring unlicensed channel usage of the AP in accordance with an updated exclusion configuration received from the PE.

2. The method of claim 1, wherein the updated exclusion configuration is received from the PE in accordance with a periodic update schedule.

3. The method of claim 1, wherein exclusion configurations of impacted APs are updated in accordance with at least one of a periodic update schedule and a pushed update responsive to detection of respective channel interference or congestion above a threshold level.

4. The method of claim 1, wherein the updated exclusion configuration is retrieved from the PE in response to a trigger condition comprising at least one of a message from the PE, a manual initialization condition, and an automatic initialization condition.

5. The method of claim 1, wherein the updated exclusion configuration is retrieved from the PE in response to detecting a beacon or a signal information indicative of an incumbent or priority users proximate the AP.

6. The method of claim 5, wherein the beacon comprises an encoded signal identifying an incumbent or priority user.

7. The method of claim 6, wherein the beacon further comprises an indication of unlicensed channel received signal strength at the incumbent or priority user.

8. The method of claim 1, wherein:
the AP is configured to communicate with other APs using unlicensed spectrum; and
configuring unlicensed channel usage of the AP in accordance with the exclusion configuration comprises establishing a schedule of unlicensed channel usage for communicating with other APs.

9. The method of claim 8, wherein responsive to receiving an updated exclusion configuration the AP communicates the updated exclusion configuration to any other APs within a common AP group.

10. The method of claim 8, wherein responsive to receiving an updated exclusion configuration the AP communicates the updated exclusion configuration to any extenders controlled by the AP.

11. The method of claim 8, further comprising:
at the AP, in further response to an initialization of the AP, enabling advertising of the AP to other APs via the predefined communications channel.

12. The method of claim 1, wherein the exclusion configuration retrieved from the PE comprises a respective portion of a restricted channels database stored at the PE.

13. The method of claim 1, wherein the exclusion configuration defines allowed channels and time slots for use by the AP.

14. The method of claim 13, wherein the exclusion configuration further defines allowed channels and time slots for different AP locations.

15. The method of claim 1, wherein the exclusion configuration defines allowed reduced power channels and time slots for use by the AP.

16. An access point (AP) configured to provide network services to mobile devices connected thereto using unlicensed spectrum shared with incumbent users, the apparatus comprising a processor configured to execute instructions stored within a tangible computer readable medium to perform an unlicensed channel exclusion enforcement method, the method comprising:
in response to an initialization of the AP, retrieving an exclusion configuration from provider equipment (PE) communicatively coupled thereto via a predefined communications channel, the exclusion configuration defining an unlicensed spectrum portion and a time period during which the AP may not use the defined unlicensed spectrum portion;
configuring unlicensed channel usage of the AP in accordance with the exclusion configuration; and
configuring unlicensed channel usage of the AP in accordance with an updated exclusion configuration received from the PE.

17. The apparatus of claim 16, wherein the exclusion configuration is received from the PE in accordance with at least one of a periodic update schedule and a pushed update responsive to detection of respective channel interference or congestion above a threshold level.

18. The apparatus of claim 16, wherein the updated exclusion configuration is retrieved from the PE in response to a trigger condition comprising at least one of a message from the PE, a manual initialization condition, and an automatic initialization condition.

19. The apparatus of claim 16, wherein the updated exclusion configuration is retrieved from the PE in response to detecting a beacon indicative of an incumbent or priority user proximate the AP.

20. The apparatus of claim 19, wherein the beacon comprises an encoded signal identifying an incumbent or priority user.

21. The apparatus of claim 20, wherein the beacon further comprises an indication of unlicensed channel received signal strength at the incumbent or priority user.

22. The apparatus of claim 16, wherein:
the AP is configured to communicate with other APs using unlicensed spectrum; and
configuring unlicensed channel usage of the AP in accordance with the exclusion configuration comprises establishing a schedule of unlicensed channel usage for communicating with other APs.

23. The apparatus of claim 22, further comprising:
at the AP, in further response to an initialization of the AP, enabling advertising of the AP to other APs via the predefined communications channel.

24. The apparatus of claim 16, wherein the exclusion configuration defines allowed reduced power channels and time slots for use by the AP.

25. A computer-implemented unlicensed channel(s) exclusion enforcement method, in a network manager managing access points (APs) configured to use unlicensed spectrum, the method comprising:
comparing managed AP locations with locations identified in a restricted channels database to identify thereby APs impacted by current or scheduled priority use of the unlicensed spectrum; and
updating exclusion configurations of each of the impacted APs, the exclusion configuration defining an unlicensed spectrum portion and a time period during which the AP may not use the defined unlicensed spectrum portion;
each of the APs being configured to retrieve from the network manager a respective exclusion configuration via a predefined communications channel in response to an initialization of the AP;
each of the APs being configured to use unlicensed spectrum in accordance with the respective exclusion configuration.

26. The method of claim 25, wherein exclusion configurations of impacted APs are updated in accordance with at least one of a periodic update schedule and a pushed update responsive to detection of respective channel interference or congestion above a threshold level.
